(19) United States
(12) Patent Application Publication
(10) Pub. No.: US 2016/0189220 A1
(43) Pub. Date: Jun. 30, 2016

(54) Context-Based Services Based on Keyword Monitoring

(71) Applicant: Audience, Inc., Mountain View, CA (US)

(72) Inventor: Tony Verma, San Francisco, CA (US)

(21) Appl. No.: 14/983,497

(22) Filed: Dec. 29, 2015

Related U.S. Application Data
(60) Provisional application No. 62/098,138, filed on Dec. 30, 2014.

(51) Int. Cl. G06Q 30/02

(52) U.S. Cl. CPC G06Q 30/0256; G06Q 30/0261

(57) ABSTRACT

Provided are systems and methods for context-based services based on keyword monitoring. An example method includes monitoring an acoustic signal associated with a user. The acoustic signal is captured by audio devices associated with the user. The method can include detecting at least one keyword in the acoustic signal and determining, based at least partially on the acoustic signal, context data associated with the at least one keyword and the user. The keyword and the context data are analyzed to determine an indication of an intent, a need, or a wish of the user. The indication can be sent to a service provider. The service provider can provide information associated with context-based services to the user. The information may include a reminder, an advertisement, a coupon, a discount offer, a rebate, and a coupon. The information can be sent when the user is located at a specific location.

### CROSS-REFERENCE TO RELATED APPLICATION

The present application claims the benefit of U.S. Provisional Patent Application No. 62/098,138, filed Dec. 30, 2014. The subject matter of the aforementioned application is incorporated herein by reference for all purposes.

### FIELD

The present application relates generally to audio processing and, more specifically, to systems and methods for context-based services based on keyword monitoring.

### BACKGROUND

Advertisers are often concerned about targeting relevant audiences in order to increase advertisement efficiency. One common solution is to provide advertisements based on contextual data. For example, the contextual data can include a user's demographics data such as a gender, age, income, location, and so forth. Web-based advertisement can use contextual data determined from screening a user's email messages and history of Internet browsing. However, known methods for context-based advertisement are limited by what data can be collected for defining contextual data and by channels of advertisement delivery.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Systems and methods for providing context-based services based on keyword monitoring are provided. An example method includes monitoring an acoustic signal associated with a user. The acoustic signal may be captured by at least one audio device of a plurality of audio devices associated with the user. The method can allow detecting at least one keyword in the acoustic signal. The method may include determining, based at least partially on the acoustic signal, context data associated with the at least one keyword and the user. The method can also allow analyzing the at least one keyword and the context data to determine an indication of at least one of the following: an intent, a need, and a wish of the user. The method may include sending the indication to a service provider. The service provider can be operable to provide information associated with context-based services to the user.

In some embodiments, the context data includes the location of the user and the method further includes: comprising configuring each of the plurality of audio devices to communicate the keyword and the location to the rest of the audio devices of the plurality of devices, the plurality of audio devices being configured to communicate with one another.

The keyword may be selected from a list of keywords. The list of keywords may be associated with the at least one audio device. In other embodiments, the list of keywords is associated with a function of the at least one audio device. The list of keywords may be associated with a location of the at least one audio device.

In various embodiments, the context data is determined based on a particular location where the keyword is detected, a timestamp created when the at least one keyword is detected, and a further acoustic sound detected concurrently with the keyword. The particular location can include at least one of the following: a car, a specific room in a house, and a place of business.

In certain embodiments, determining the indication of the user's intent, user's wish, or user's need includes counting a number of detections of the keyword within a pre-determined time period.

In some embodiments, determining the context data comprises detecting a proximity of the user to the at least one audio device. The indication sent to the service provider may include the location of the user. The method may further include receiving information from the service provider, the information including a reminder for a specific event, a reminder of a specific action, an advertisement, a coupon, or a rebate.

In various embodiments, the plurality of the audio devices includes one or more of the following: a smartphone, a TV set, a light switch, a thermostat, a car control system, an audio system, and a home control system.

According to another example embodiment of the present disclosure, the steps of the method for providing context-based services based on keyword monitoring are stored on a non-transitory machine-readable medium comprising instructions, which when implemented by one or more processors perform the recited steps.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 is a block diagram illustrating an environment in which methods for providing context-based services based on keyword monitoring can be practiced, according to various example embodiments.

FIG. 2 is a block diagram illustrating an audio device, according to an example embodiment.

FIG. 3 is a block diagram illustrating an example system for providing context-based services based on keyword monitoring.

FIG. 4 is a flow chart showing a method for providing context-based services based on keyword monitoring, according to an example embodiment.

FIG. 5 illustrates an example computer system that can be used to implement embodiments of the disclosed technology.

### DETAILED DESCRIPTION

The technology disclosed herein relates to systems and methods for providing context-based services based on keyword monitoring. According to some example embodiments, an example system for providing context-based services based on keyword monitoring is operable to passively monitor acoustic sounds associated with a user and detect keywords in the acoustic sounds. In some embodiments, the system includes an integrated circuit (chip) configured to operate in an “always on” lower power mode. In certain embodiments, the chip is embedded in an audio device. The chip can be operable to detect context data associated with the keyword. The keyword and context data can be analyzed to detect an intent of the user. The analysis can be carried out locally on the chip and/or the audio device. In some embodiments, the analysis and/or detection is carried out remotely in a computing cloud. An indication of the user intent can be sent to a service provider. Based on the user intent, the service provider can deliver information or advertisements to the user, make notes in the user's calendar, send reminders, and so forth.

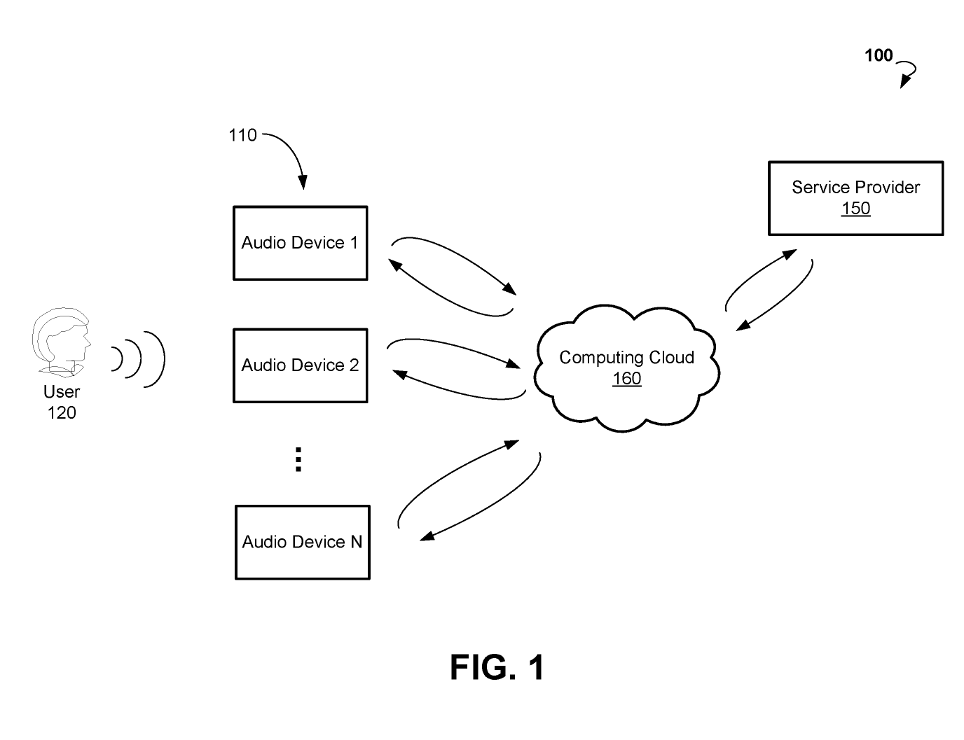

FIG. 1 is a block diagram illustrating an environment 100, wherein a method for providing context-based services based on keyword monitoring can be practiced, according to an example embodiment. The example environment 100 includes one or more audio device(s) 110. In some embodiments, the audio device(s) 110 include stationary devices and are located at different places in a home and/or office of a user 120. Some audio devices 110 (for example, smartphones and wearables) can move with the user 120.

In some embodiments, each of the audio devices 110 is configured to operate in an “always on” mode to passively monitor for acoustic signals. In other embodiments, the audio device(s) 110 operate in a low power mode while monitoring for acoustic signals. The acoustic signals can be received and recorded at a low bit rate. The acoustic signals may include a voice of the user 120. In various embodiments, the audio device(s) 110 are interconnected via a network. In some embodiments, the network includes a local network, for example Wi-Fi network, Bluetooth network, and the like. The audio device(s) 110 are operable to process the acoustic signal(s) to detect one or more keywords and/or key phrases.

In various embodiments, the audio device(s) 110 are connected to a cloud-based computing resource(s) 160 (also referred to herein as a computing cloud). The cloud-based computing resource(s) 160 can include one or more server farms/clusters comprising a collection of computer servers and co-located with network switches and/or routers.

In some embodiments, the example environment includes at least one service provider 150. Service provider 150 can be communicatively connected to a computing cloud 160 and to one or more audio device(s) 110 (for example, a smartphone, a personal computer, a TV set, and so forth) of the user 120. The service provider 150 may be operable to receive data associated with the user 120, for example, keywords, context data, a user profile, and so forth. In various embodiments, the service provider 150 is operable to send, based on the received data, information that the user 120 may be interested in (for example, a reminder, an advertisement, a coupon, and so forth), to one or more audio device(s) 110 or to another device of the user 120.

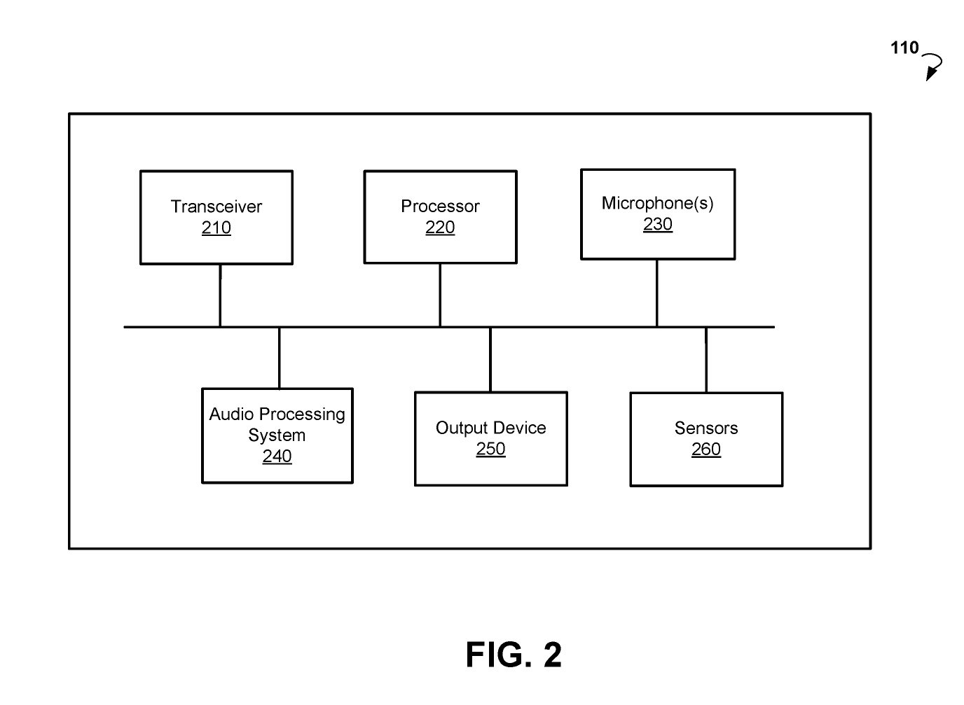

FIG. 2 is a block diagram illustrating an example audio device 110 suitable for implementing keyword monitoring and context data acquisition, according to some embodiments. The example audio device 110 can include a transceiver 210, a processor 220, one or more microphone(s) 230, an audio processing system 240, an output device 250, and sensors 260. In certain embodiments, the audio device 110 includes additional or different components to provide a particular operation or functionality. Similarly, the audio device 110 may include fewer components that perform similar or equivalent functions to those described with reference to FIG. 2.

In some embodiments, the transceiver 210 is configured to communicate with a network such as the Internet, a Wide Area Network (WAN), a Local Area Network (LAN), a cellular network, and so forth, to receive and/or transmit an audio data stream. The received audio data stream may then be forwarded to the audio processing system 240 and the output device 250.

The processor 220 can include hardware and software that implement the processing of audio data and various other operations depending on the type of the audio device 110 (e.g., a communication device and a computer), according to some embodiments. A memory (e.g., a non-transitory computer readable storage medium) can be operable to store, at least in part, instructions and data for execution by processor 220.

In various embodiments, the audio processing system 240 includes hardware and software that implement the encoding of acoustic signal(s). For example, the audio processing system 240 can be configured to receive acoustic signals from an acoustic source via microphone(s) 230 (which may be one or more microphones or acoustic sensors) and to process the acoustic signals. After receipt by the microphone(s) 230, the acoustic signals may be converted into electric signals by an analog-to-digital converter. In some embodiments, the processing of acoustic signal(s) include noise suppression and/or noise reduction. Noise can be defined as unwanted sound including, for example, street noise, ambient noise, and speech from entities other than an intended speaker. For example, noise sources can include a working air conditioner, a ventilation fan, a TV set, a mobile phone, a stereo audio system, and the like. Certain kinds of noise may arise from both operations of machines (for example, cars) and the environments in which they operate (for example, a road, a track, a tire, a wheel, a fan, a wiper blade, an engine, an exhaust, an entertainment system, wind, rain, waves, and the like).

An example audio processing system suitable for performing noise suppression is discussed in more detail in U.S. patent application Ser. No. 12/832,901 (now U.S. Pat. No. 8,473,287), entitled “Method for Jointly Optimizing Noise Reduction and Voice Quality in a Mono or Multi-Microphone System,” filed Jul. 8, 2010, the disclosure of which is incorporated herein by reference for all purposes. By way of example and not limitation, noise suppression methods are described in U.S. patent application Ser. No. 12/215,980 (now U.S. Pat. No. 9,185,487), entitled “System and Method for Providing Noise Suppression Utilizing Null Processing Noise Subtraction,” filed Jun. 30, 2008, and in U.S. patent application Ser. No. 11/699,732 (now U.S. Pat. No. 8,194,880), entitled “System and Method for Utilizing Omni-Directional Microphones for Speech Enhancement,” filed Jan. 29, 2007, which are incorporated herein by reference in their entireties.

The output device 250 is any device that provides an audio output to a listener (e.g., an acoustic source). For example, the output device 250 may comprise a speaker, a class-D output, an earpiece of a headset, or a handset of the audio device 110.

In various embodiments, sensors 260 include, but not limited to, an accelerometer, magnetometer, gyroscope, Inertial Measurement Unit (IMU), temperature sensor, altitude sensor, proximity sensor, barometer, humidity sensor, color sensor, light sensor, pressure sensor, Global Positioning System (GPS) module, beacon, WiFi sensor, ultrasound sensor, infrared sensor, and touch sensor.

In certain embodiment, any of audio device(s) 110 are operable to exchange sensor data, captured acoustic signals, and user data with another audio device and the computing cloud 160 (as shown in FIG. 1).

In some embodiments, the microphone(s) 230, processor 220, audio processing system 240, sensors 260, and memory are integrated as one chip unit. The chip can operate in a low power and/or “always on” mode and record the acoustic signals at a low bit rate. The chip can be embedded in an audio device 110.

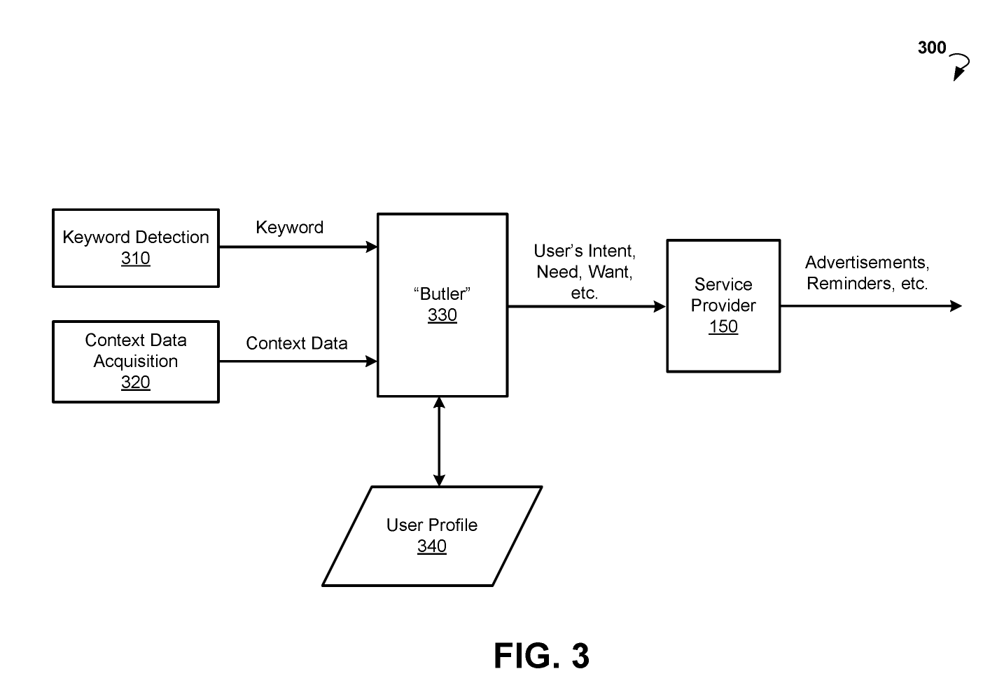

FIG. 3 is a block diagram illustrating a system 300 for providing context-based services based on keyword monitoring, according to some example embodiments. The illustrated system 300 includes a keyword detection module 310, a context data acquisition module 320, and a “butler” 330. In some embodiments, the “butler” 330 is operable to send data to service provider 150 (also shown in FIG. 1). In various embodiments, the “butler” is associated with a user profile 340. Modules 310-330 of system 300 can be implemented as instructions stored in a memory of either audio device(s) 110 or computing cloud 160 (shown in FIG. 1). The instructions may be executed “locally” by at least one processor of the audio device(s) 110 or “remotely” by at least one processor associated with the computing cloud 160, depending on requirements for time and power of computational resources needed for execution of the instructions.

In some embodiments, the keyword detection module 310 is operable to detect a keyword or a key phrase in an acoustic signal captured by at least one audio device 110. The keyword or the key phrase can be selected from a pre-determined list of words (for example, “car,” “birthday,” “grocery,” “shopping,” and so forth). In certain embodiments, an initial keyword detection can be performed by audio device 110. In further embodiments, each audio device 110 can be associated with a specific list of keywords and key phrases. The specific list can be determined based on function or type of an audio device 110 (e.g., a smartphone, a TV set, a light switch, and a thermostat) and/or location of the audio device 110. For example, the audio device 110 can be located in a kitchen near a refrigerator, or in a living room, garage, car, and so on.

In other embodiments, context data acquisition module 320 is operable to collect sensor data and determine a context data associated with the keyword or the key phrase uttered by a user. Audio device(s) 110 can detect a location of the user using sensors, for example, a proximity sensor, a temperature sensor, an infrared sensor, and the like. In certain embodiments, the location of the user can be determined from the user's smartphone using GPS data or identifiers associated with a communication network (for example, a cellular phone network or Internet). The audio device(s) 110 can be operable to capture and detect additional sounds other than the user's voice. The additional sounds can be used by context data acquisition module 320 to determine or clarify the context data.

In various embodiments, detected keywords, key phrases, and/or context data (for example, a location where the keyword was detected, a timestamp generated when the keyword was detected, additional sounds detected with the keyword, and so on) are sent to “butler” 330 for analysis. The “butler” 330 may include a service application associated with the computing cloud 160 (shown in FIG. 1). The “butler” 330 can be operable to analyze the received keyword(s) and context data to determine (and, in some cases, anticipate) a possible need, intention, or wish of the user 120. In other embodiments, the analysis of the keyword and context data can be carried out locally on one or more of the audio device(s) 110. In yet other embodiments, one of the audio device(s) 110 performs a partial analysis of a keyword and context data before sending the keyword and the context data to computing cloud 160 for further processing. For example, one of the audio device(s) 110 can be operable to count how many times the user 120 utters a particular keyword and/or key phrase. In certain embodiments, if the count exceeds a pre-determined number, the audio device 110 sends an indication that the pre-determined number has been exceeded to the computing cloud to be analyzed by “butler” 330.

In some embodiments, the “butler” 330 is configured to determine and track the user's habit or characteristic behavior, regular traveling schedule, places regularly attended, waking and sleeping pattern, and so forth, for generating or updating the user profile 340. In certain embodiments, the “butler” 330 is configured to stop monitoring for keywords and context data when the user 120 is located at the user's work place, and to start the monitoring when the user 120 is back home or arrives at a public place other than the user's work place.

In some embodiments, the data indicative of the user's intention, wish, and/or need, as determined by the “butler” 330, is sent to at least one service provider 150 (also shown in FIG. 1). Based on the user's intent, wish, and need, the service provider 150 may provide one or more services to the user 120. For example, the user 120 can receive context-based information or advertisements when watching a TV set in the living room at home. The context-based information or advertisements are determined based on the user's determined intention, wish, and/or need. The service provider 150 may be operable to send messages and reminders to the user's smartphone, for example. In some embodiments, the messages are sent when the user 120 enters a particular place of business, like a grocery store.

In various embodiments, the user 120 authorizes service provider 150 to monitor spoken keywords, key phrases, context data, and the like, and to provide the services in exchange for coupons, discounts, rebates, and the like. The classification of keywords and analyzing of the user's data can be performed locally or remotely (in a computing cloud, for example) based on the subscription policy and privacy.

### Example 1

For example, a user 120 can walk into a kitchen, open a refrigerator, and utter a phrase like, “Oh, I guess I am out of milk.” An audio device 110 located near the refrigerator can detect the words “milk” and “out.” Based on its knowledge that keywords “milk” and “out” were uttered near the refrigerator, the “butler” 330 sends an indication to a service provider 150 that the user 120 needs to buy milk. The service provider 150 sends a message reminding the user 120 to buy milk the next time the “butler” 330 determines that the user 120 walks into a grocery store. In some embodiments, the user's device(s) are configured to “serve” (e.g., display, notify, etc.) information or advertisements(s) related to milk to the user 120, for example, to influence the buying decision, or to automatically send an order for milk to a service which the user 120 uses for ordering dairy items.

### Example 2

For example, a user 120 located at home (in a living room) can utter, “Oh, my mom's birthday is coming up.” An audio device 110 located in the living room can detect the words “mom” and “birthday.” Based on the detected words, the “butler” 330 can determine that the user 120 may need flowers and/or a gift and can send the indication of this need to a service provider 150. The service provider 150 may then send a message to the user 120 with a list of florists or a list of gifts that can be purchased on the Internet. The service provider 150 can also make a note in the user's calendar. In some embodiments, a user's device (such as a TV, a cable box, a cell phone, or the like) is configured, for example, based on input from the service provider 150, to “serve” advertisement(s) related to flowers or gifts to the user 120 to prompt the user 120 to use a particular service to order the flowers or gifts.

### Example 3

A “butler” 330 may detect that a user 120 utters the words “car” and “buying” several times during a day, for example. The “butler” 330 can determine that the user 120 intends to buy a car. The “butler” 330 can then send the indication of the user's intent to a service provider 150. The service provider 150 can then show the user 120 a particular car advertisement when the user 120 watches TV at home.

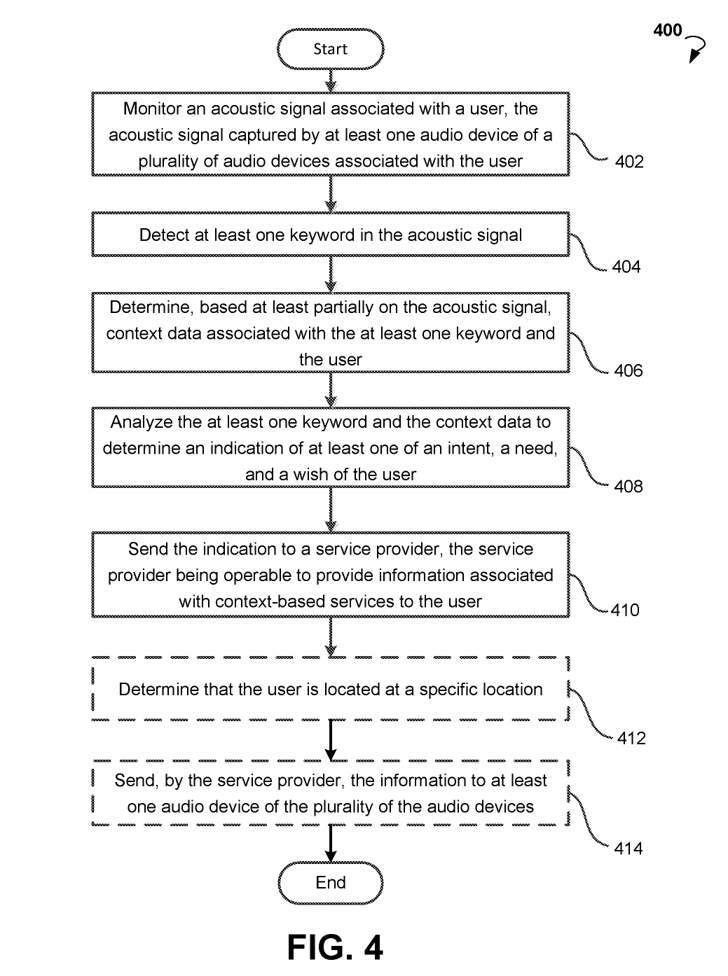

FIG. 4 is a flow chart showing steps of a method 400 for providing context-based services based on keyword monitoring, according to an example embodiment. The example method 400 can commence with monitoring an acoustic signal associated with a user in block 402. The acoustic signal can be captured by at least one audio device of a plurality of audio devices associated with a user.

In block 404, example method 400 can proceed with detecting at least one keyword in the acoustic signal. In block 406, example method 400 proceeds with determining, based at least partially on the acoustic signal, context data associated with the keyword and the user. In block 408, the at least one keyword and the context data can be analyzed to determine an indication of at least one of an intent, a need, and a wish of the user. In block 410, the indication can be sent to a service provider. In some embodiments, the service provider is operable to provide information associated with context-based services to the user.

In various embodiments, optionally, in block 412, example method 400 can determine that the user is located at a specific location (for example, a business place). Optionally, in block 414, example method 400 can send by the service provider, in response to the determination of the user's location, information to one of the audio devices of the plurality of audio devices. In various embodiments, the information includes a reminder of a specific event or a specific action, an advertisement, a coupon, a discount offer, a rebate, a coupon, and the like.

Embodiments of the present technology can be practiced with at least one audio device operable at least to capture acoustic signals. Audio devices can further include: radio frequency (RF) receivers, transmitters, and transceivers; wired and/or wireless telecommunications and/or networking devices; amplifiers; audio and/or video players; encoders; decoders; speakers; inputs; outputs; storage devices; and user input devices. According to various embodiments, audio devices include devices where spoken audio keywords may be captured. For example, audio devices may include hand-held devices, such as wired and/or wireless remote controls, notebook computers, tablet computers, phablets, smart phones, personal digital assistants (PDAs), media players, mobile telephones, and the like. In certain embodiments, the audio devices may include other suitable voice-controllable devices that use audio keywords, e.g., smart TV sets, vehicle control systems, smart thermostats, smart light switches, and the other suitable devices that use audio keywords.

In various embodiments, the audio devices operate in stationary and portable environments. Stationary environments can include residential and commercial buildings or structures, and the like. For example, the stationary embodiments can include living rooms, bedrooms, home theaters, conference rooms, auditoriums, business premises, and the like. Portable environments can include moving vehicles, moving persons, and other transportation means.

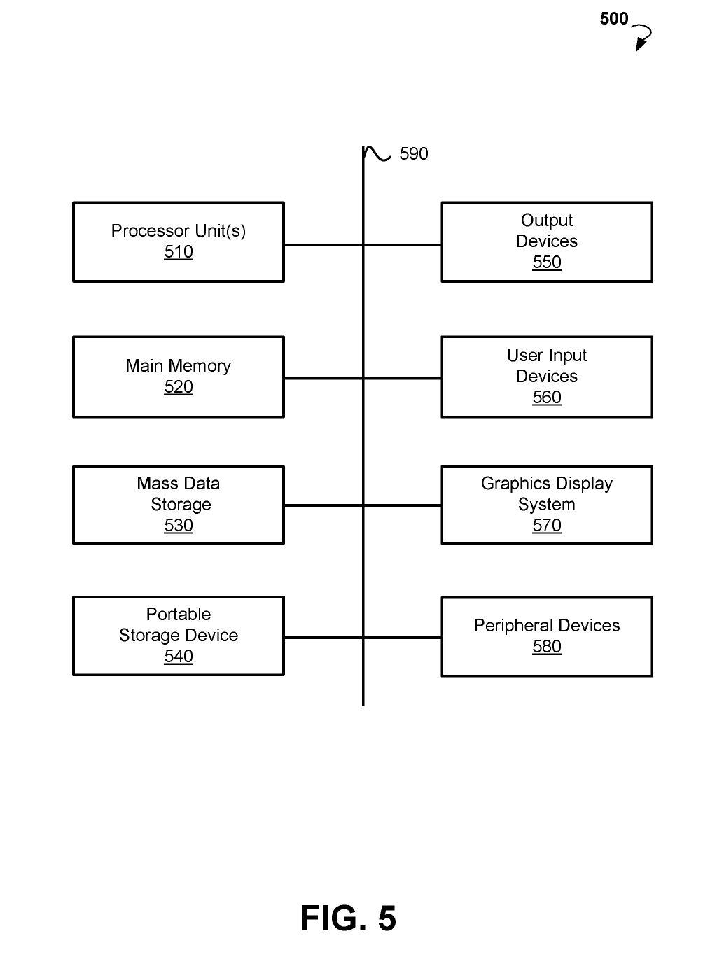

FIG. 5 illustrates an exemplary computer system 500 that may be used to implement some embodiments of the present invention. The computer system 500 of FIG. 5 may be implemented in the contexts of the likes of computing systems, networks, servers, or combinations thereof. The computer system 500 of FIG. 5 includes one or more processor units 510 and main memory 520. Main memory 520 stores, in part, instructions and data for execution by processor unit(s) 510. Main memory 520 stores the executable code when in operation, in this example. The computer system 500 of FIG. 5 further includes a mass data storage 530, portable storage device 540, output devices 550, user input devices 560, a graphics display system 570, and peripheral devices 580.

The components shown in FIG. 5 are depicted as being connected via a single bus 590. The components may be connected through one or more data transport means. Processor unit(s) 510 and main memory 520 are connected via a local microprocessor bus, and the mass data storage 530, peripheral device(s) 580, portable storage device 540, and graphics display system 570 are connected via one or more input/output (I/O) buses.

Mass data storage 530, which can be implemented with a magnetic disk drive, solid state drive, or an optical disk drive, is a non-volatile storage device for storing data and instructions for use by processor unit(s) 510. Mass data storage 530 stores the system software for implementing embodiments of the present disclosure for purposes of loading that software into main memory 520.

Portable storage device 540 operates in conjunction with a portable non-volatile storage medium, such as a flash drive, floppy disk, compact disk, digital video disc, or Universal Serial Bus (USB) storage device, to input and output data and code to and from the computer system 500 of FIG. 5. The system software for implementing embodiments of the present disclosure is stored on such a portable medium and input to the computer system 500 via the portable storage device 540.

User input devices 560 can provide a portion of a user interface. User input devices 560 may include one or more microphones, an alphanumeric keypad, such as a keyboard, for inputting alphanumeric and other information, or a pointing device, such as a mouse, a trackball, stylus, or cursor direction keys. User input devices 560 can also include a touchscreen. Additionally, the computer system 500 as shown in FIG. 5 includes output devices 550. Suitable output devices 550 include speakers, printers, network interfaces, and monitors.

Graphics display system 570 include a liquid crystal display (LCD) or other suitable display device. Graphics display system 570 is configurable to receive textual and graphical information and processes the information for output to the display device.

Peripheral devices 580 may include any type of computer support device to add additional functionality to the computer system.

The components provided in the computer system 500 of FIG. 5 are those typically found in computer systems that may be suitable for use with embodiments of the present disclosure and are intended to represent a broad category of such computer components that are well known in the art. Thus, the computer system 500 of FIG. 5 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

The processing for various embodiments may be implemented in software that is cloud-based. In some embodiments, the computer system 500 is implemented as a cloud-based computing environment, such as a virtual machine operating within a computing cloud. In other embodiments, the computer system 500 may itself include a cloud-based computing environment, where the functionalities of the computer system 500 are executed in a distributed fashion. Thus, the computer system 500, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing systems, such as the computer system 500, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A method for providing context-based services, the method comprising:
monitoring an acoustic signal associated with a user, the acoustic signal being captured by at least one audio device of a plurality of audio devices associated with the user;
detecting at least one keyword in the acoustic signal;
determining, based at least partially on the acoustic signal, context data associated with the at least one keyword and the user;
analyzing the at least one keyword and the context data to determine an indication of an intent, a need, or a wish associated with the user; and
sending the indication to a service provider, the service provider being operable to provide information associated with context-based services to the user.

2. The method of claim 1, wherein the context data includes a particular location where the keyword was detected, the method further comprising configuring each of the plurality of audio devices to communicate the keyword and the location to the rest of the audio devices of the plurality of devices, the plurality of audio devices being configured to communicate with one another.

3. The method of claim 2, wherein the particular location includes a specific room in a house or place of business.

4. The method of claim 1, wherein the at least one keyword is selected from a list of keywords, the list of keywords being associated with the at least one audio device of the plurality of audio devices.

5. The method of claim 4, wherein the list of keywords is associated with a function of the at least one audio device of the plurality of audio devices.

6. The method of claim 4, wherein the list of keywords is associated with a location of the at least one audio device of the plurality of audio devices.

7. The method of claim 1, wherein the context data is determined based on at least one of the following: a timestamp generated when the at least one keyword was detected, and a further acoustic sound detected concurrently with the at least one keyword.

8. The method of claim 1, wherein the determining the context data includes detecting a proximity of the user to the at least one audio device of the plurality of audio devices.

9. The method of claim 1, wherein the indication sent to the service provider includes the location of the user.

10. The method of claim 1, further comprising receiving information from the service provider, the information including a reminder for a specific event, a reminder of a specific action, an advertisement, a coupon, or a rebate.

11. The method of claim 1, wherein the plurality of audio devices includes one or more of the following: a smartphone, a TV set, a light switch, a thermostat, a car control system, an audio system, and a home control system.

12. A system for providing context-based services, the system comprising:
a processor; and
a memory communicatively coupled with the processor, the memory storing instructions which, when executed by the processor, performs a method comprising:
monitoring an acoustic signal associated with a user, the acoustic signal being captured by at least one audio device of a plurality of audio devices associated with the user;
detecting at least one keyword in the acoustic signal;
determining, based at least partially on the acoustic signal, context data associated with the at least one keyword and the user;
analyzing the at least one keyword and the context data to determine an indication of at least one of the following: an intent, a need, and a wish of the user; and
sending the indication to a service provider, the service provider being operable to provide information associated with context-based services to the user.

13. The system of claim 12, wherein the context data includes a particular location where the keyword was detected, each of the plurality of audio devices being configured to communicate the keyword and the location to the rest of the audio devices of the plurality of devices, the plurality of audio devices being configured to communicate with one another.

14. The system of claim 13, wherein the particular location includes a specific room in a house or place of business.

15. The system of claim 12, wherein the at least one keyword is selected from a list of keywords, the list of keywords being associated with the at least one audio device of the plurality of audio devices.

16. The system of claim 15, wherein the list of keywords is associated with a function of or a location of the at least one audio device of the plurality of audio devices.

17. The system of claim 12, wherein the context data is determined based on at least one of the following: a timestamp generated when the at least one keyword was detected, and a further acoustic sound detected concurrently with the at least one keyword.

18. The system of claim 12, wherein determining the indication includes counting a number of detections of the at least one keyword within a pre-determined time period.

19. The system of claim 12, wherein the indication sent to the service provider includes the location of the user.

20. The system of claim 12, wherein the method further includes receiving information from the service provider, the information including a reminder for a specific event, a reminder of a specific action, an advertisement, a coupon, or a rebate.

21. A non-transitory computer-readable storage medium having embodied thereon instructions, which, when executed by at least one processor, perform steps of a method, the method comprising:
monitoring an acoustic signal associated with a user, the acoustic signal being captured by at least one audio device of a plurality of audio devices associated with the user;
detecting at least one keyword in the acoustic signal;
determining, based at least partially on the acoustic signal, context data associated with the at least one keyword and the user;
analyzing the at least one keyword and the context data to determine an indication of at least one of the following: an intent, a need, and a wish of the user; and
sending the indication to a service provider, the service provider being operable to provide information associated with context-based services to the user.
